(19) United States
(12) Patent Application Publication
(10) Pub. No.: US 2025/0005242 A1
(43) Pub. Date: Jan. 2, 2025

(54) METHODOLOGY FOR PREDICTION OF PPA DESIGN

(71) Applicant: Taiwan Semiconductor Manufacturing Company, Ltd., Hsinchu (TW)

(72) Inventors: CHUNG-HSING WANG, Hsinchu (TW); Ping Hsiu WEI, Taoyuan (TW); Chia-Chung CHEN, Keelung (TW); Chung-Sheng YUAN, Hsinchu City (TW); Yi-Kan CHENG, Taipei (TW)

(73) Assignee: Taiwan Semiconductor Manufacturing Company, Ltd., Hsinchu (TW)

(21) Appl. No.: 18/476,394

(22) Filed: Sep. 28, 2023

Related U.S. Application Data
(60) Provisional application No. 63/510,403, filed on Jun. 27, 2023.

(51) Int. Cl. G06F 30/3308; G06F 30/394; G06F 30/398

(52) U.S. Cl. CPC G06F 30/3308; G06F 30/394; G06F 30/398

(57) ABSTRACT

A computer-implemented method includes: placing and routing design elements in a simulation environment; applying one or more simulation conditions to the design elements; obtaining a first set of data based on the one or more simulation conditions, and a first relationship between the first set of data; obtaining a prediction model based on the first relationship; and predicting a new set of data using the prediction model.

### REFERENCE TO RELATED APPLICATION

This application claims the benefit of U.S. Provisional Application No. 63/510,403, filed on Jun. 27, 2023, entitled “Novel Methodology to Predict PPA design in Advanced Semiconductor Technology,” the entirety of which is incorporated by reference herein.

### BACKGROUND

As semiconductor technology advances, new processes or technologies for integrated circuits manufacturing continuously emerge, and the complexity of integrated circuits design also continues to increase, leading to increased cost and time associated with manufacturing the integrated circuits. Therefore, it is important to be able to predict the performance of the integrated circuits under a new process or technology and optimize the design of the integrated circuits before adopting the new process or technology in manufacturing.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a method for prediction of performance, power, and area (PPA) of an electronic product, in accordance with some embodiments of the present disclosure.

FIG. 2 is a schematic diagram illustrating exemplary power vs. speed relationships for an electronic product under different technologies, in accordance with some embodiments of the present disclosure.

FIG. 3 is a schematic diagram illustrating a method for prediction of PPA, in accordance with some embodiments of the present disclosure.

FIG. 4 is a schematic diagram illustrating a method for prediction of PPA, in accordance with some embodiments of the present disclosure.

FIG. 5 is a schematic diagram illustrating a speed gain at the same power and a power reduction at the same speed for technology-2 of FIG. 4, in accordance with some embodiments of the present disclosure.

FIG. 6 is a schematic diagram illustrating an adjustment of PnR PPA data, in accordance with some embodiments of the present disclosure.

FIG. 7 is a schematic diagram illustrating a method for prediction of PPA of a next technology, in accordance with some embodiments of the present disclosure.

FIG. 8 is a schematic diagram illustrating evaluation of a next technology PPA benefit at any voltage points, in accordance with some embodiments of the present disclosure.

FIG. 9 is a flow chart illustrating a method for predicting a PPA design for a next technology, in accordance with some embodiments of the present disclosure.

FIG. 10, which is a schematic diagram illustrating a device for predicting a PPA design for a next technology, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

To predict performance of a product under a new process or technology, during each simulation, new parameters from a library can be applied. However, this may prolong cycle time and increase resource expenses. Also, conventional PPA format uses speed verses core area, which unable to demonstrate advanced technology PPA benefit. At least some embodiments described in this disclosure overcome the above-noted issues of conventional methods.

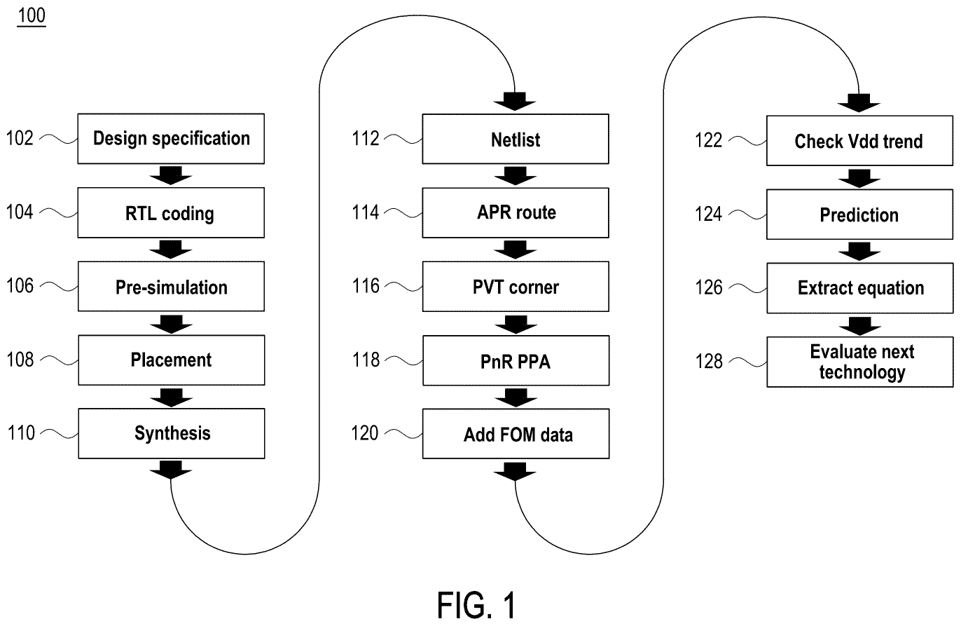

Reference is made to FIG. 1, which is a schematic diagram illustrating a design flow 100 for prediction of performance, power, and area (PPA) of an electronic product, in accordance with some embodiments of the present disclosure. Design flow 100 can be used for prediction of PPA of any product or component, including, but not limited to, integrated circuits (ICs), transistors, systems-on-chip, etc. The product may be a test product under a new process or technology. The new process or technology described in this disclosure can be any process or technology that is different from a process or technology currently adopted in manufacturing. The difference can be a difference of one or more parameters. Design flow 100 can be performed in any computer system or computing device.

Referring to FIG. 1, Design flow 100 includes a stage 102 of providing design specification of an electronic product. In an embodiment, the electronic product is an integrated circuit to be fabricated using a new process or technology. The integrated circuit design may include one or more blocks, and each block may include a plurality of sub-blocks and/or circuit components. The circuit components may include one or more logic components, one or more memory components, and connection wiring.

Design flow 100 may include a stage 104 of performing a register transfer level (RTL) coding on the design specification. For example, in an embodiment, by using the RTL coding, a high-level representation of the integrated circuit is created. The RTL coding can be performed using a hardware description language, for example, but is not limited to, Verilog, VHSIC hardware description language (VHDL), or System Verilog.

Design flow 100 may include a stage 106 of generating a pre-simulation of the design specification. For example, in an embodiment, a pre-simulation of the circuit schematics of the integrated circuit can be generated using a set of executable instructions.

Design flow 100 may include a stage 108 of performing a layout placement. For example, in an embodiment, an integrated circuit layout placement is provided based on one or more design constraints.

Design flow 100 may include a stage 110 of performing synthesis. For example, in an embodiment, a logic synthesis and/or high-level synthesis can be performed to the integrated circuit layout.

Design flow 100 may include a stage 112 of producing a netlist of the design. For example, a netlist including a list of electronic components in the integrated circuit and a list of nodes they are connected to can be produced. In some embodiments, the netlist is a gate-level netlist. In some embodiments, the stage 110 and the stage 112 are merged into one stage so that the netlist is produced in the synthesis stage.

Design flow 100 may include a stage 114 of performing an automated placement and routing (APR). For example, in an embodiment, in the APR route stage of the design flow, a gate-level netlist is physically implemented in the integrated circuit layout by placing cells and auto-routing the cells based on the connections inferred from the netlist.

Design flow 100 may include a stage 116 of process, voltage, and temperature (PVT) corners optimization. The process, voltage, and temperature may represent operation condition parameters for estimating performance of an electronic product being designed. For example, in an embodiment, the design of the integrated circuit can be optimized for a corner (e.g., a possible variation in a process, voltage, or temperature). In some embodiments, the PVT corner optimization process may optimize the design across all PVT corners.

Design flow 100 may include a stage 118 of placing and routing (PnR) the optimized design elements in a simulation environment. For example, in an embodiment, the design of the integrated circuit can be placed and routed in a simulation environment.

Design flow 100 may include a stage 120 of adding figure of merit (FOM) data to the optimized design elements. For example, in an embodiment, one or more simulation conditions of interest may be applied to the design of the integrated circuit.

Design flow 100 may include a stage 122 of checking Vdd trend. Vdd may represent a supply voltage or a maximum amount of voltage available for an electronic product being designed. For example, in an embodiment, when the reference voltage of the integrated circuit design is a ground that is assigned zero volts, the value of Vdd represents the supply voltage. In this embodiment, the power and speed values under different Vdd values can be estimated (simulated), for example, using a real data point as a starting point. The range of Vdd can be any range, for example, a range from 0.4V to 1.2V. In this way, a set of data of the simulation conditions is obtained. For example, a set of data in a power vs. speed coordinate can be obtained, in which each data point is obtained under a different Vdd value. Further, a relationship between the set of data points can also be obtained. In an embodiment, such a Vdd trend check can be performed for a first technology, and for a second technology and a first relationship between a first set of data and a second relationship between a second set of data can be obtained. The first technology and the second technology may be are known technologies or processes.

Design flow 100 may include a stage 124 of prediction. For example, in an embodiment, a prediction model based on the first relationship and the second relationship is obtained. In an embodiment, the correlation between the first relationship and the second relationship can also be determined.

Design flow 100 may include a stage 126 of extracting an equation. In an embodiment, the equation may be polynomial regression, for example, y=x²+x+c, where x represents speed, y represents power, and c represents a constant. In an embodiment, the x² may dominate at low Vdd, and the constant c may dominate at very low Vdd. In an embodiment, the stage 124 and the stage 126 can be merged into one stage so that the prediction stage include the process of extracting equations from a set of data.

Design flow 100 may include a stage 128 of evaluating a next technology. The next technology can be a currently existing technology or process, a new technology or process, or a future developed technology or process for manufacturing an electronic product. For example, in an embodiment, a third set of data is obtained using the prediction model determined based on the first relationship and the second relationship. In an embodiment, the next technology can be evaluated by comparing a speed at a certain power under the next technology with a speed at the same power under the first and/or second technology. If there is a speed gain at the same power for the next technology, then it may be concluded that the next technology has an advantage compared to the first or the second technology. In an embodiment, the next technology can be evaluated by comparing a power consumption at a certain speed under the next technology with a power consumption at the same speed under the first and/or second technology. If there is power decrease at the same speed for the next technology, then it may be concluded that the next technology has an advantage compared to the first or the second technology.

In this way, before adopting a new technology or process in manufacturing, the PPA design of an electronic product under the new technology or process can be determined, and the potential benefits or drawbacks of the new technology or process can be estimated, thereby reducing cost and increasing efficiency of manufacturing.

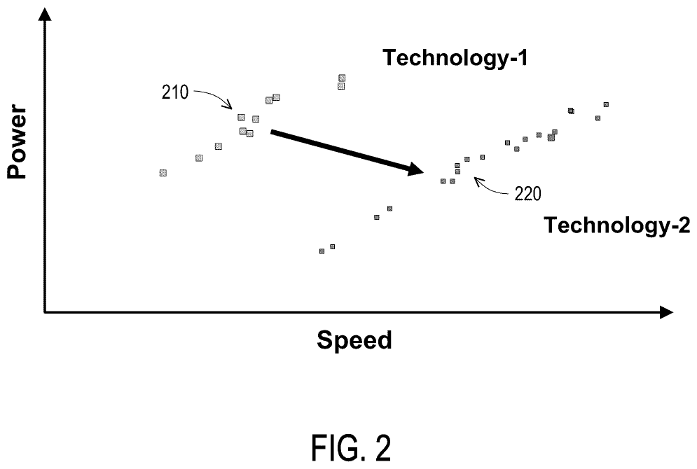

References are made to FIG. 2, which is a schematic diagram illustrating exemplary power vs. speed relationships for an electronic product under different technologies, in accordance with some embodiments of the present disclosure. Referring to FIG. 2, a set of points 210 represents power vs. speed relationship for an electronic product under a first technology (technology-1). Similarly, a set of points 220 represents power vs. speed relationship for the electronic product under a second technology (technology-2). The speed may be a maximum operating speed that the electronic product can be achieved. In an embodiment, a higher speed may indicate a better performance of the electronic product. Each point in the set of points 210 may correspond to a different Vdd value. Similarly, each point in the set of points 220 may correspond to a different Vdd value. In an embodiment, an initial placing and routing (PnR) PPA are performed under the same supply voltage, for example, Vdd=0.9V or 0.6V. The arrow from the set of points 210 to the set of points 220 indicates correspondence between points under the same simulation conditions. For example, each corresponding pair of data points under two different technologies may have the same supply voltage. As shown in FIG. 2, under technology-2, an electronic product consumes less power while having higher operating speed.

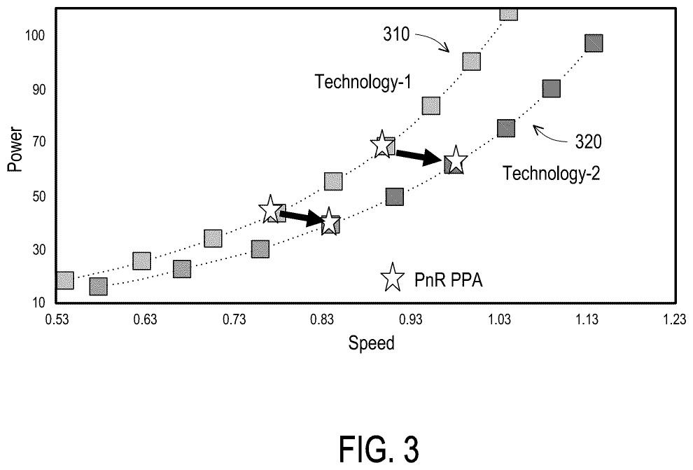

References are made to FIG. 3, which is a schematic diagram illustrating a method for prediction of PPA, in accordance with some embodiments of the present disclosure. Referring to FIG. 3, a set of points 310 represents power vs. speed relationship for an electronic product under a first technology (technology-1). Similarly, a set of points 320 represents power vs. speed relationship for the electronic product under a second technology (technology-2). In an embodiment, technology-1 is a known technology or process, and the technology-2 is a new technology or process. Each point in the set of points 310 may correspond to a different Vdd value. Each point in the set of points 310 may be a real data point (e.g., a data point obtained by testing a product) under technology-1. In this embodiment, using the set of points 310 of known technology-1, the set of points 320 of a new technology are predicted based on a prediction model determined using the set of points 310. For example, the prediction model can be obtained based on the relationship between the set of data points 310. The relationship can be expressed using an equation, for example, a polynomial regression. Using the prediction model, the set of points 320 can be obtained. For example, each of the set of data points 310 may have a corresponding data point in the second set 320, as indicated by the arrows in FIG. 3. In this way, using known data of a known technology, the PPA data of an unknown technology can be predicted.

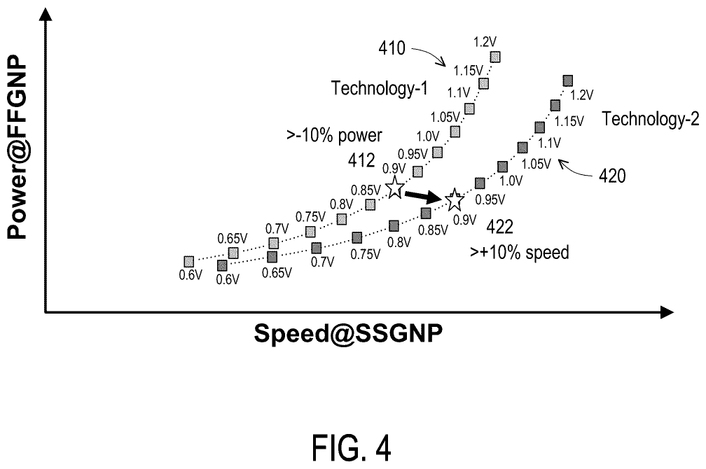

References are made to FIG. 4, which is a schematic diagram illustrating a method for prediction of PPA, in accordance with some embodiments of the present disclosure. Referring to FIG. 4, a set of points 410 represents power vs. speed relationship for an electronic product under a first technology (technology-1). Similarly, a set of points 420 represents power vs. speed relationship of the electronic product under a second technology (technology-2). In an embodiment, the technology-1 is a known technology or process, and the technology-2 is a new technology or process. In this embodiment, among the set of points 410, only one point (represented by a star 412 in FIG. 4) is a real data point and other data points are predicted (simulated) data points. Similarly, among the set of points 420, only one point (represented by a star 422 in FIG. 4) is real data and other data points are predicted data. The prediction (simulation) may be performed within a certain Vdd range, for example, from 0.6V to 1.2V, as shown in FIG. 4. However, the Vdd range is not so limited, it can be any voltage range suitable for the electronic product being designed. FOM data can be extracted by an equation, for example, a polynomial regression. The simulation results fully match with the regression prediction, as indicated by R²=1. As shown in FIG. 2, under the same Vdd, compared with technology-1, the electronic product under technology-2 requires less power (about 10% less) while having higher operating speed (about 10% higher).

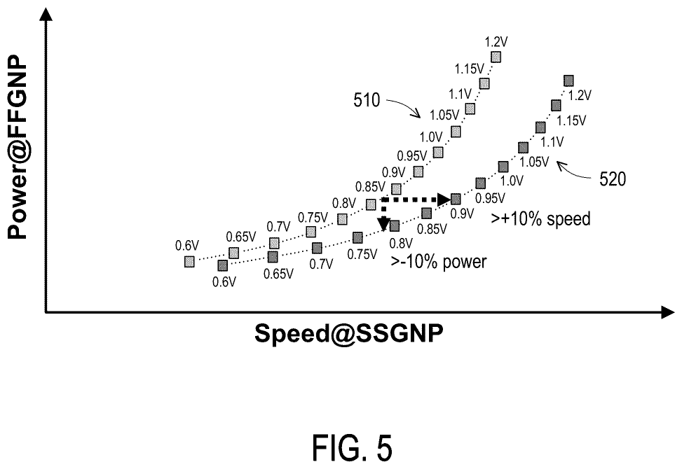

References are made to FIG. 5, which is a schematic diagram illustrating a speed gain at the same power and a power reduction at the same speed for technology-2 of FIG. 4, in accordance with some embodiments of the present disclosure. Referring to FIG. 5, a set of points 510 represents power vs. speed relationship for an electronic product under a first technology (technology-1). Similarly, a set of points 520 represents power vs. speed relationship for the electronic product under a second technology (technology-2). The set of points 510 and the set of points 520 correspond to the set of points 410 and the set of points 420 of FIG. 4, respectively. For the sake of brevity, repeated descriptions for FIG. 5 are omitted here. As shown in FIG. 5, under the same power consumption, the electronic product under technology-2 has higher operating speed, compared with that of technology-1. The speed again obtained under technology-2 is about 10% or more. And under the same speed, the electronic product under technology-2 has less power requirement, compared with that of technology-1. The power reduction obtained under technology-2 is about 10% or more.

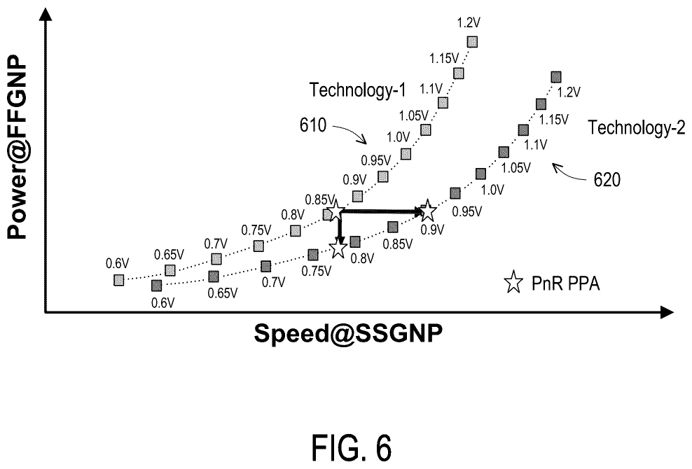

References are made to FIG. 6, which is a schematic diagram illustrating an adjustment of PnR PPA data, in accordance with some embodiments of the present disclosure. Referring to FIG. 6, in an embodiment, PnR PPA data can be adjusted by a toggle ratio, which causes changes in an equation variation. In this way, the prediction model can be optimized, leading to increased accuracy of predictions.

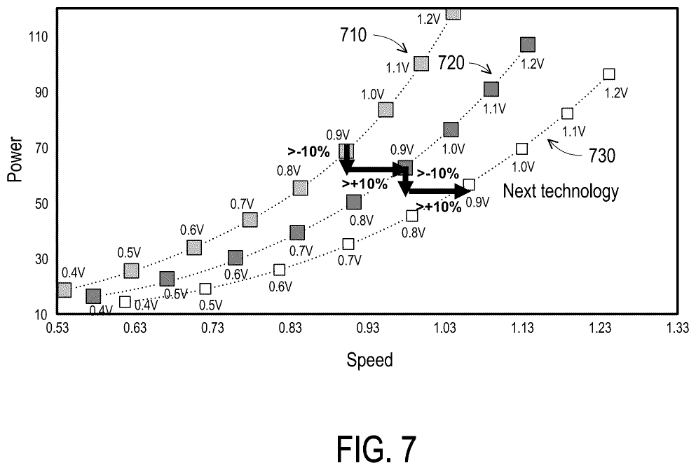

References are made to FIG. 7, which is a schematic diagram illustrating a method for prediction of PPA of a next technology, in accordance with some embodiments of the present disclosure. Referring to FIG. 7, a set of data points 710 represents power vs. speed relationship for an electronic product under a first technology (technology-1), a set of data points 720 represents power vs. speed relationship for the electronic product under a second technology (technology-2), and a set of data points 730 represents power vs. speed relationship for the electronic product under a next technology. In an embodiment, technology-1 and technology-2 are known technologies and the set of points 710 and the set of points 720 are known data points under technology-1 and under technology-2, respectively. In this embodiment, a first relationship between the set of points 710 can be obtained. Similarly, a second relationship between the set of points 720 can also be obtained. Based on the first relationship and the second relationship, a prediction model can be obtained. For example, the correlation between the first relationship and the second relationship can be determined and the prediction model can be determined based on the correlation. The prediction model can be expressed as an equation (e.g., polynomial regression). Using the prediction model, the set of points 730 can be predicted. As shown in FIG. 7, compared with technology-1, under the same power consumption, the speed again obtained under technology-2 is about 10% or more. And, compared with technology-1, under the same speed, the power reduction obtained under technology-2 is about 10% or more. On the other hand, compared with technology-2, under the same power consumption, the speed again obtained under the next technology is about 10% or more. And, compared with technology-2, under the same speed, the power reduction obtained under the next technology is about 10% or more.

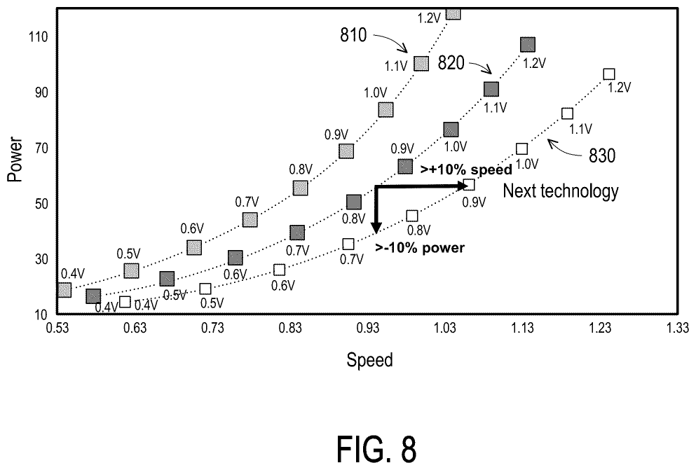

Reference is made to FIG. 8, which is a schematic diagram illustrating evaluation of a next technology PPA benefit at any voltage points, in accordance with some embodiments of the present disclosure. Referring to FIG. 8, in an embodiment, the prediction model for the next technology is expressed using an equation (e.g., polynomial regression). Using the equation, the next technology PPA benefit at any voltage point can be estimated. For example, as shown in FIG. 8, compared with the technology-2, under the same power consumption, the speed again obtained under the next technology is about 10% or more. And, compared with the technology-2, under the same speed, the power reduction obtained under the next technology is about 10% or more.

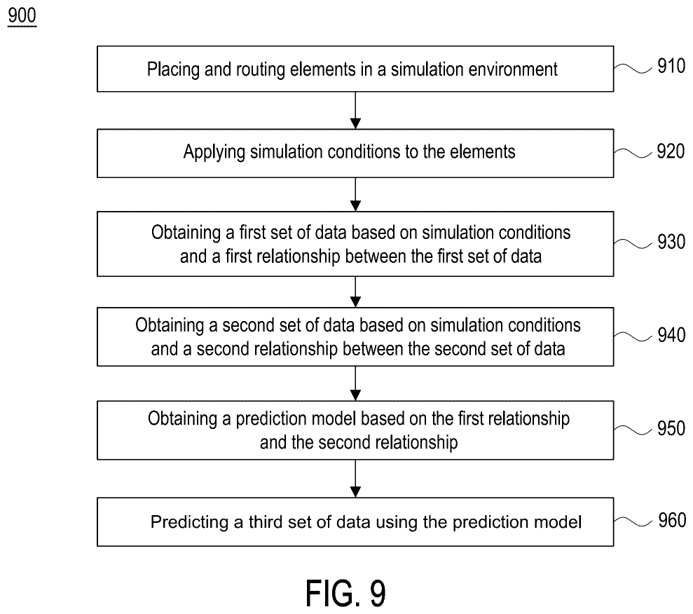

Reference is made to FIG. 9, which is a flow chart illustrating a method 900 for predicting a PPA design for a next technology, in accordance with some embodiments of the present disclosure. For better understanding of the present disclosure, the method 900 is discussed in relation to embodiments shown in FIG. 1 to FIG. 8, but is not limited thereto. As shown in FIG. 9, in some embodiments, the method 900 includes operations 910-960.

The method 900 includes an operation 910 of placing and routing elements in a simulation environment. For example, as shown in FIG. 1, a design flow includes a stage of placing and routing design elements in a simulation environment. For example, in an embodiment, the design is a design of an integrated circuit based on a next technology, and the elements are the elements of the integrated circuit being designed.

The method 900 includes an operation 920 of applying simulation conditions to the elements. For example, as shown in FIG. 1, the design flow includes a stage of applying FOM data (e.g., simulation conditions of interest) to the design elements. In an embodiment, the simulation conditions may include a supply voltage Vdd.

The method 900 includes an operation 930 of obtaining a first set of data based on one or more simulation conditions and a first relationship between the first set of data. For example, as shown in FIG. 7, the set of data points 710 in a power v. speed coordinate is obtained and the relationship (first relationship) between the set of data points is also obtained. The first relationship can be expressed using an equation (e.g., a polynomial). In an embodiment, the first set of data may be obtained at a plurality of supply voltage Vdd. For example, in an embodiment, the range of Vdd can be 0.4-1.2V.

The method 900 includes an operation 940 of obtaining a second set of data based on the simulation conditions and a second relationship between the second set of data. For example, as shown in FIG. 7, the set of data points 720 in a power v. speed coordinate is obtained and a relationship (second relationship) between the data points is also obtained. The second relationship can be expressed using an equation (e.g., a polynomial). In an embodiment, the second set of data can be obtained at a plurality of supply voltage Vdd. For example, in an embodiment, the range of Vdd can be 0.4-1.2V. In an embodiment, operation 940 is omitted and the method for predicting a PPA design for a next technology may be performed based on the first set of data and the first relationship.

The method 900 includes an operation 950 of obtaining a prediction model based on the first relationship and the second relationship. For example, the prediction model can be expressed using an equation (e.g., polynomial). In an embodiment, the prediction model may be obtained based on a correlation between the first and second relationships. For example, the prediction model may be obtained by adjusting the second relationship based on the correlation between the first and second relationships.

The method 900 includes an operation 960 of predicting a third set of data using the prediction model. For example, as shown in FIG. 7, a set of data points 730 are obtained using the prediction model. The third set of data may be obtained at a plurality of supply voltage Vdd. For example, in an embodiment, the range of Vdd can be 0.4-1.2V. In this way, using real data under a known technology, data of a new technology can be predicted. The benefits or the drawbacks of the new technology can be further estimated by comparing speeds at the same power under the known and the new technologies, or by comparing powers at the same speed under the known and the new technologies.

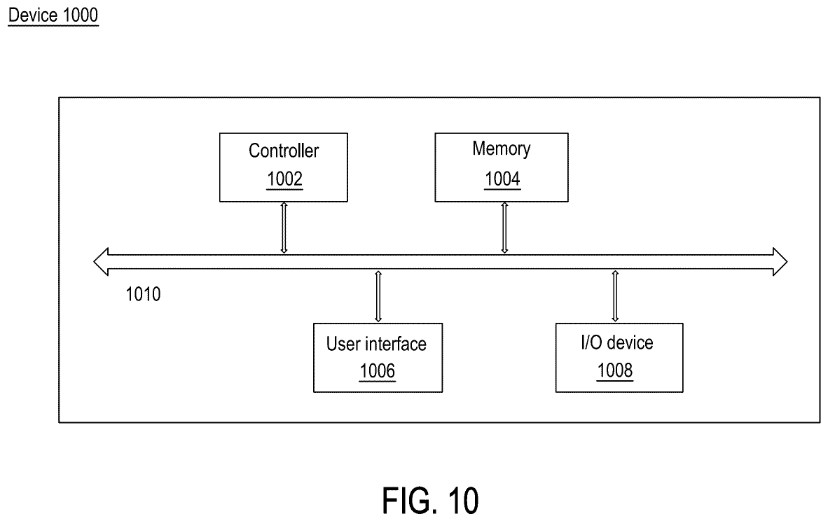

Reference is made to FIG. 10, which is a schematic diagram illustrating a device 1000, in accordance with some embodiments of the present disclosure. Device 1000 can be any computing device that can implement the prediction of PPA design for a next technology, as discussed with respect to FIGS. 1-9. Device 1000 may be a data or information processing device such as a CAD tool, a personal computer or a workstation. As shown in FIG. 10, device 1000 includes a controller 1002 for carrying out operations for the design of a layout, for example, as shown in FIG. 1 and FIG. 9. Device 1000 also includes a memory 1004 for storing design information (e.g., integrated circuit information) and other information such as design rules. Device 1000 includes a user interface 1006 for displaying information and inputting user commands. Device 1000 includes an input/output (I/O) device 1008 for receiving information and providing the design results.

The controller 1002 may include a processor (e.g., a CPU) for executing prescribed processes in accordance with programs, and a computer readable storage medium for storing programs in the form of computer program code i.e., a set of executable instructions. In some embodiments, the processor may execute one or more sets of instructions stored within the computer readable storage medium for the design. In other embodiments, the processor is an application specific integrated circuit configured with one or more hardwired sets of instructions for execution. In some embodiments, the computer readable storage medium is an electronic, magnetic, optical, electromagnetic, infrared, and/or a semiconductor system (or apparatus or device). For example, the computer readable storage medium may include a semiconductor or solid-state memory, a magnetic tape, a removable computer diskette, a random access memory (RAM) a read-only memory (ROM), a rigid magnetic disk, and/or an optical disk. In some embodiments, using optical disks, the computer readable medium includes a compact disk-read only memory (CD-ROM), a compact disk read/write (CD-R/W), and/or a digital video disc (DVD).

The above illustrations include exemplary operations, but the operations are not necessarily performed in the order shown. Operations may be added, replaced, changed order, and/or eliminated as appropriate, without departing from the spirit and scope of the present disclosure.

In some embodiments, a computer-implemented method for estimating PPA for a product design is disclosed. The method includes: placing and routing design elements in a simulation environment; applying one or more simulation conditions to the design elements; obtaining a first set of data based on the one or more simulation conditions, and a first relationship between the first set of data; obtaining a prediction model based on the first relationship; and predicting a new set of data using the prediction model.

In some embodiments, an apparatus for estimating PPA for a product design is disclosed. The apparatus includes a memory device storing instructions; and a processor configured to execute the instructions stored in the memory device to cause the apparatus to: place and route design elements in a simulation environment; apply one or more simulation conditions to the design elements; obtain a first set of data based on the one or more simulation conditions, and a first relationship between the first set of data; obtain a prediction model based on the first relationship; and predict a new set of data using the prediction model.

In some embodiments, non-transitory computer readable medium storing a set of instructions that is executable by one or more processors of an apparatus to cause the apparatus to perform a method is disclosed. The method comprises: placing and routing design elements in a simulation environment; applying one or more simulation conditions to the design elements; obtaining a first set of data based on the one or more simulation conditions, and a first relationship between the first set of data; obtaining a prediction model based on the first relationship; and predicting a new set of data using the prediction model.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-implemented method for estimating a power, performance, and area (PPA) for a product design, the method comprising:
placing and routing design elements in a simulation environment;
applying one or more simulation conditions to the design elements;
obtaining a first set of data based on the one or more simulation conditions, and a first relationship between the first set of data;
obtaining a prediction model based on the first relationship; and
predicting a new set of data using the prediction model.

2. The method of claim 1, wherein the method further comprises:
obtaining a second set of data based on the one or more simulation conditions, and a second relationship between the second set of data;
and wherein obtaining the prediction model further comprises:
obtaining the prediction model based on the first relationship and the second relationship.

3. The method of claim 1, wherein the product design is a design of an integrated circuit.

4. The method of claim 2, wherein obtaining the prediction model comprises determining an equation based on the first relationship and the second relationship.

5. The method of claim 2, wherein at least one of obtaining the first set of data or obtaining the second set of data comprises obtaining a set of data determined by a power and a speed.

6. The method of claim 2, wherein the first set of data is based on a first technology, the second set of data is based on a second technology, and the new set of data is based on a third technology.

7. The method of claim 6, further comprising: evaluating the third technology by comparing a speed at a power under the third technology and a speed at the power under the second technology.

8. The method of claim 6, further comprising: evaluating the third technology by comparing a power at a speed under the third technology and a power at the speed under the second technology.

9. An apparatus for estimating a power, performance, and area (PPA) for a product design, comprising:
a memory device storing instructions; and
a processor configured to execute the instructions stored in the memory device to cause the apparatus to:
place and route design elements in a simulation environment;
apply one or more simulation conditions to the design elements;
obtain a first set of data based on the one or more simulation conditions, and a first relationship between the first set of data;
obtain a prediction model based on the first relationship; and
predict a new set of data using the prediction model.

10. The apparatus of claim 9, wherein the processor is further configured to execute the instructions stored in the memory device to cause the apparatus to:
obtain a second set of data based on the one or more simulation conditions, and a second relationship between the second set of data;
and wherein, in obtaining the prediction model, the processor is further configured to execute the instructions stored in the memory device to cause the apparatus to:
obtain the prediction model based on the first relationship and the second relationship.

11. The apparatus of claim 9, wherein the product design is a design of an integrated circuit.

12. The apparatus of claim 10, wherein obtaining the prediction model comprises determining an equation based on the first relationship and the second relationship.

13. The apparatus of claim 10, wherein at least one of obtaining the first set of data or obtaining the second set of data comprises obtaining a set of data determined by a power and a speed.

14. The apparatus of claim 10, wherein the first set of data is based on a first technology, the second set of data is based on a second technology, and the new set of data is based on a third technology.

15. The apparatus of claim 14, wherein the processor is further configured to execute the instructions stored in the memory device to cause the apparatus to
evaluate the third technology by comparing a speed at a power under the third technology and a speed at the power under the second technology.

16. The apparatus of claim 14, wherein the processor is further configured to execute the instructions stored in the memory device to cause the apparatus to:
evaluate the third technology by comparing a power at a speed under the third technology and a power at the speed under the second technology.

17. A non-transitory computer readable medium storing a set of instructions that is executable by one or more processors of an apparatus to cause the apparatus to perform a method comprising:
placing and routing design elements in a simulation environment;
applying one or more simulation conditions to the design elements;
obtaining a first set of data based on the one or more simulation conditions, and a first relationship between the first set of data;
obtaining a prediction model based on the first relationship; and
predicting a new set of data using the prediction model.

18. The non-transitory computer readable medium of claim 17, wherein the method further comprises:
obtaining a second set of data based on the one or more simulation conditions, and a second relationship between the second set of data;
and wherein obtaining the prediction model further comprises:
obtaining the prediction model based on the first relationship and the second relationship.

19. The non-transitory computer readable medium of claim 17, wherein the product design is a design of an integrated circuit.

20. The non-transitory computer readable medium of claim 18, wherein obtaining the prediction model comprises determining an equation based on the first relationship and the second relationship.
